(19) United States
(12) Patent Application Publication
(10) Pub. No.: US 2016/0209706 A1
(43) Pub. Date: Jul. 21, 2016

(54) DISPLAY DEVICE

(71) Applicant: Japan Display Inc., Tokyo (JP)

(72) Inventors: Hirohisa Miki, Tokyo (JP); Shigesumi Araki, Tokyo (JP); Kazuhiro Nishiyama, Tokyo (JP)

(21) Appl. No.: 14/986,341

(22) Filed: Dec. 31, 2015

(30) Foreign Application Priority Data
Jan. 21, 2015 (JP) 2015-009657

(51) Int. Cl. G02F 1/1335; G02F 1/1368

(52) U.S. Cl. CPC G02F 1/133617; G02F 1/1368; G02F 1/133512; G02F 1/133528; Y10S 977/765; Y10S 977/952; B82Y 20/00

(57) ABSTRACT

There is provided a display device that can improve the use efficiency of light from a light source and achieve low power consumption with a simple configuration even in the case in which no color filter is used. A display device includes a substrate having a display region and a TFT disposed on the display region, wavelength conversion layers each including a columnar quantum rod and disposed on a region corresponding to the display region, and a light source that excites the quantum rods.

### CLAIM OF PRIORITY

The present application claims priority from Japanese patent application JP 2015-9657 filed on Jan. 21, 2015, the content of which is hereby incorporated by reference into this application.

### BACKGROUND OF THE INVENTION

(1) Field of the Invention

The present invention relates to a display device.

(2) Description of the Related Art

A liquid crystal display device, which is one of display devices, has merits, such as high display quality, thin thickness, light weight, and low power consumption. The applications of the liquid crystal display device are expanding because of these merits. The liquid crystal display device is used in various applications including a portable monitor, such as a mobile telephone monitor and a digital still camera monitor, a desktop personal computer monitor, monitors for printing and design, a medical monitor, and a liquid crystal television.

More specifically, mobile electronic devices, which are represented by a smartphone and a tablet, are installed with a display screen. For these mobile electronic devices, increasing development is to decrease power consumption and to prolong continuous service hours. Since displays are components that consume power more than other components, displays of lower power consumption are being developed. More specifically, color filters used for color display cut many wavelength components from light emitted from a white light source, and have a low use efficiency of light. Therefore, a technique is proposed in which fluorescent dye is used instead of color filters (e.g. Japanese Unexamined Patent Application Publication No. 2013-254071).

### SUMMARY OF THE INVENTION

### Problems to be Solved by the Invention

A display device using fluorescent dye includes a fluorescent material layer and other components, such as a fluorescent reflective layer that reflects produced phosphor and prevents phosphor from entering a TFT substrate, an optical absorption layer that absorbs light from the outside such as sunlight and luminous light and prevents light from entering a fluorescent material film, an optical reflective layer that reflects and emits phosphor to the outside, and a barrier having an inclined plane. Thus, the configuration is complicated, which leads to concern about costs.

It is an object of the present invention to provide a display device that can improve the use efficiency of light from a light source and achieve low power consumption with a simple configuration even in the case in which no color filter is used.

### Means for Solving the Problems

An aspect of achieving the object is a display device including: a substrate having a display region and a thin film transistor disposed on the display region; a wavelength conversion layer disposed on a region corresponding to the display region and including a columnar quantum rod having a major axis and a minor axis; and a light source that excites the quantum rod.

Another aspect of achieving the object is a display device including: a first substrate having a display region including a blue pixel region, a red pixel region, and a green pixel region, a thin film transistor disposed on the display region, a scanning signal line electrically connected to a gate electrode of the thin film transistor, and a picture signal line electrically connected to a source electrode of the thin film transistor; a second substrate formed with a black matrix, the second substrate being disposed opposed to the first substrate, the black matrix being formed between pixel regions adjacent to each other, the pixel region corresponding to the blue pixel region, the red pixel region, or the green pixel region; a liquid crystal layer sandwiched between the first substrate and the second substrate; a wavelength conversion layer disposed on a region corresponding to the display region and including a plurality of columnar quantum rods having a major axis and a minor axis; a quantum rod alignment unit disposed at a location overlapping with the black matrix when viewed from perpendicularly above for aligning an orientation of the plurality of quantum rods; a light source that excites the plurality of quantum rods; and a first polarizer, to the liquid crystal layer, disposed near to the light source and a second polarizer, to the liquid crystal layer, disposed on the opposite side of the light source.

### BRIEF DESCRIPTION OF THE DRAWINGS

FIG. 1 is a cross sectional view of main components of an example of a liquid crystal display device according to a first embodiment of the present invention;

FIG. 2 is a schematic diagram for explaining the polarization states of light in the liquid crystal display device according to the first embodiment of the present invention (in the case in which the transmission axes of polarizers are in parallel with the C-axis of a quantum rod);

FIG. 3 is a schematic diagram for explaining other polarization states of light in the liquid crystal display device according to the first embodiment of the present invention (in the case in which the transmission axes of the polarizers are perpendicular to the C-axis of the quantum rod);

FIG. 4 is a schematic diagram for explaining the polarization states of light in the case in which the transmission axes of the polarizers are perpendicular to the C-axis of the quantum rod in the liquid crystal display device according to the first embodiment of the present invention;

FIG. 5 is a schematic plan view of a display region of the liquid crystal display device according to the first embodiment and a liquid crystal display device according to a second embodiment of the present invention;

FIG. 6 is an exemplary schematic plan view of the liquid crystal display device according to the first and second embodiments of the present invention; and

FIG. 7 is a schematic diagram for explaining the polarization states of light in the liquid crystal display device according to the second embodiment of the present invention (in the case in which the transmission axes of polarizers are in parallel with the C-axis of a quantum rod).

### DETAILED DESCRIPTION

The present inventors investigated a display device in a simple configuration with no use of color filters and fluorescent dye, and the present inventors thought to use a quantum semiconductor. More specifically, the present inventors thought that a rod-like quantum semiconductor, which is a quantum rod e.g. a quantum nanowire and a quantum wire, is used to form a simple structure. In other words, in the case of a columnar quantum rod whose external form has a major axis and a minor axis, light incident in the minor axis direction is emitted in the major axis direction. Consequently, the axial directions of the quantum rods are aligned, and thus the directions of light emitted from the quantum rods can be aligned with no complicated structure as described in Japanese Unexamined Patent Application Publication No. 2013-254071.

In the following, embodiments of the present invention will be described in detail. The present disclosure is merely an example. A person skilled in the art would easily think of appropriate modifications and alterations within the gist of the present invention, which are of course included in the scope of the present invention. In the drawings, in order to more clarify the description, the width, thickness, shape, and other parameters of components are sometimes schematically illustrated as compared with actual forms. However, these parameters are merely examples, and do not limit the interpretation of the present invention. In the embodiments of the present invention, a liquid crystal display device will be described. However, the embodiments of the present invention are not limited to the liquid crystal display device, and are also applicable to an organic electro-luminescence display, for example. In the present specification and the drawings, components similar to the components already described in the drawings earlier are designated the same reference numerals and signs, and the detailed description are sometimes appropriately omitted.

### First Embodiment

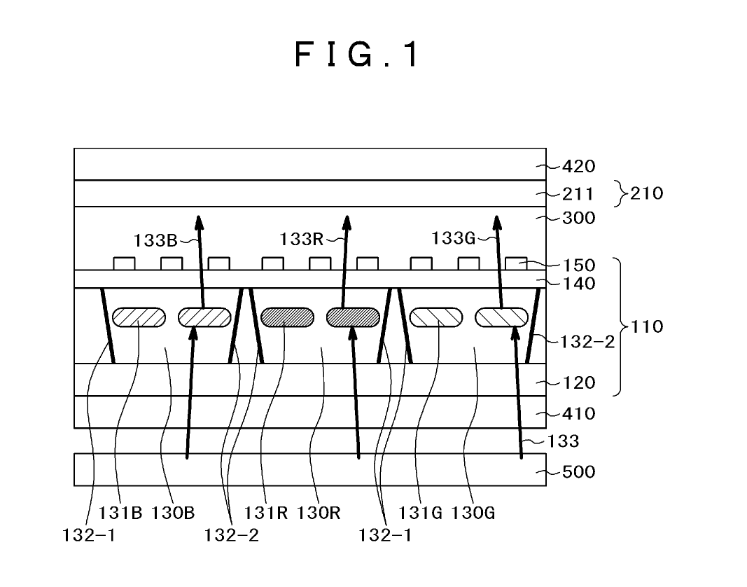

A liquid crystal display device according to a first embodiment of the present invention will be described with reference to FIGS. 1 to 6.

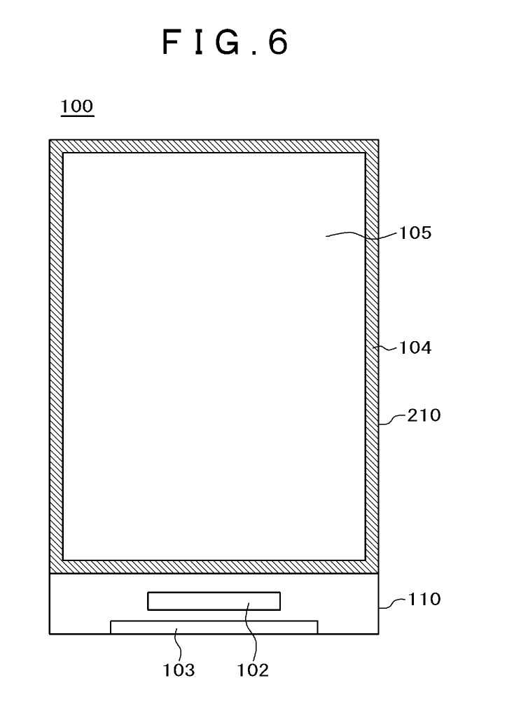

FIG. 6 is a schematic plan view of a liquid crystal display device according to the first embodiment. As illustrated in FIG. 6, a liquid crystal display device 100 includes a TFT substrate (an array substrate) 110, a counter substrate 210, and a liquid crystal layer (not illustrated) between the TFT substrate 110 and the counter substrate 210. The TFT substrate 110 is attached to the counter substrate 210 with a sealing material 104. On a display region 105 of the TFT substrate 110, scanning signal lines, picture signal lines, pixels disposed on a matrix configuration, a wavelength conversion layer including quantum rods and disposed at a location corresponding to the transmission region of the pixel, and other components are formed. The pixel includes a thin film transistor (TFT), a pixel electrode, a common electrode, and other components. A scanning signal interconnection is connected to the gate electrode of the TFT. The scanning signal interconnection is formed in the same process and formed of the same material of the gate electrode. The picture signal line is connected to the source electrode of the TFT. The picture signal line is formed in the same process and formed of the same material of the source electrode. The pixel electrode is connected to the drain electrode of the TFT.

However, for example, the designations “source” and “drain” are used for convenience. In the case in which one is designated a source, the other can be referred to as a drain. For the source electrode and the drain electrode, an aluminum silicon alloy (AlSi alloy) and a molybdenum tungsten alloy (MoW alloy), for example, can be used. For the pixel electrode and the common electrode, a transparent conductive film can be used, such as Indium Tin Oxide (ITO) and Indium Zinc Oxide (IZO). The counter substrate 210 includes a black matrix disposed at locations corresponding to the picture signal lines and the scanning signal lines, for example.

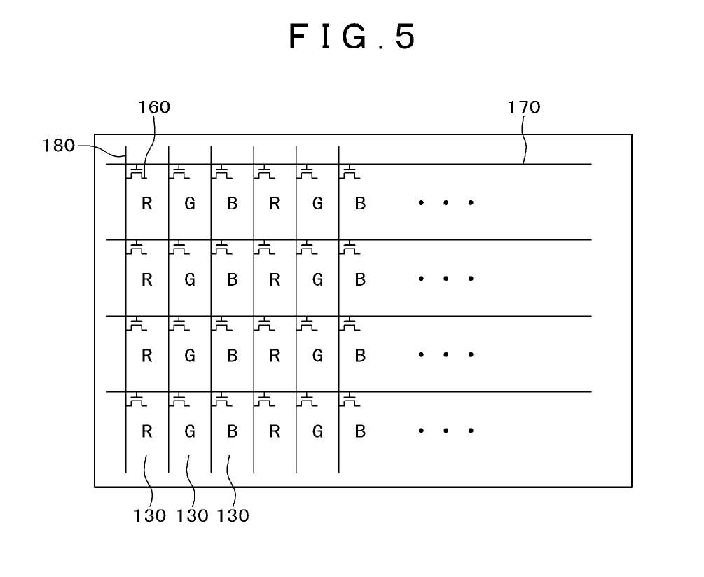

As illustrated in FIG. 5, the display region 105 of the liquid crystal display device 100 includes vertical stripe subpixels formed with a wavelength conversion layer 130 in red (R), green (G), or blue (B). The subpixels are disposed as the R, G, and B subpixels form one pixel. Each of the subpixels includes a thin film transistor (TFT) 160. A scanning signal line (a gate line) 170 is connected to the gate electrode of the TFT 160. A picture signal line (a source line) 180 is connected to the source electrode of the TFT 160.

As illustrated in FIG. 6, the TFT substrate 110 is greater than the counter substrate 210, and has a region where only the TFT substrate is provided. On the region, a substrate terminal portion 103 is disposed. To the substrate terminal portion 103, an IC driver (a drive circuit) 102 and a flexible circuit board are connected. On the back side of the TFT substrate, a backlight is disposed for emitting white light and blue light to be applied to the quantum rods. Depending on purposes, an outer frame and other components can be combined.

Next, FIG. 1 is a cross sectional view of the liquid crystal display device according to the embodiment illustrating a portion including the wavelength conversion layer. As illustrated in FIG. 1, in the embodiment, the TFT substrate 110 includes a glass substrate 120 disposed with the TFTs (not illustrated), and a wavelength conversion layer 130 formed on the TFT substrate 110 and having a wavelength conversion layer 130B including a quantum rod (in the following, referred to as a blue quantum rod) 131B that emits blue light caused by pumping light, a wavelength conversion layer 130R including a quantum rod (in the following, referred to as a red quantum rod) 131R that emits red light, and a wavelength conversion layer 130G including a quantum rod (in the following, referred to as a green quantum rod) 131G that emits green light, and quantum rod alignment electrodes 132-1 and 132-2. The TFT substrate 110 further includes a common electrode 140 formed on the wavelength conversion layer 130, and a pixel electrode 150 in a comb tooth shape connected to the drain electrode of the TFT 160. The quantum rod alignment electrodes 132-1 and 132-2 are disposed so as to overlap with the black matrix when viewed from vertically above. In the case in which a metal is used for the material of the quantum rod alignment electrodes 132-1 and 132-2, the electrodes also function as a reflective film.

The quantum rod has a shell formed of ZnS and a core formed of CdSe, for example. The quantum rod is known in which the major axis of the quantum rod is matched with the C-axis of a wurtzite crystal and polarized light is emitted in parallel with the major axis. Quantum rods having the diameter of the core in a range of 1 to 20 nm can be used. The shell has any number of layers. Two layers and three layers are possible. The outer side of the shell of the quantum rod can be modified with an organic molecule (e.g. CH) having a high affinity for a solvent. The quantum rod used for display devices is excited with a waveband of 200 to 490 nm. The sizes of the core and the shell or the aspect ratio of the major axis to the minor axis are changed, and thus polarized light at various wavelengths is emitted. In the embodiment, the wavelength conversion layer 130 is disposed on the TFT substrate 110. However, the wavelength conversion layer 130 can also be disposed on the counter substrate 210. In the case in which the wavelength conversion layer 130 is disposed on the TFT substrate 110, the quantum rod is prevented from glowing caused by natural light. In the case in which the wavelength conversion layer 130 is disposed on the counter substrate 210, previously existing manufacture processes can be used.

The red (R), green (G), and blue (B) wavelength conversion layers 130R, 130G, and 130B and the quantum rod alignment electrodes 132-1 and 132-2 can be formed using in combination of publicly known manufacture techniques, such as photolithography, ink jet, and vacuum evaporation, suitable for the properties of materials. As in publicly known techniques, the quantum rods 131R, 131G, and 131B can be aligned by applying an electric field to the quantum rod alignment electrodes 132-1 and 132-2.

The counter substrate 210 includes a glass substrate 211 formed with the black matrix (not illustrated). The liquid crystal layer 300 is sandwiched between the TFT substrate 110 and the counter substrate 210. To the liquid crystal layer 300, a light source (backlight: BL) 500 is disposed opposed to the TFT substrate 110. To the liquid crystal layer 300, a first polarizer 410 is disposed opposed to the light source 500. To the liquid crystal layer 300, a second polarizer 420 is disposed on the opposite side of the light source 500, i.e. on the counter substrate 210.

In the embodiment, the light source 500 emits ultraviolet light (white light) 133 to the wavelength conversion layer 130, and then the blue quantum rod 131B emits blue light 133B, the red quantum rod 131R emits red light 133R, and the green quantum rod 131G emits green light 133G. Thus, the use efficiency of light is improved, which allows low power consumption.

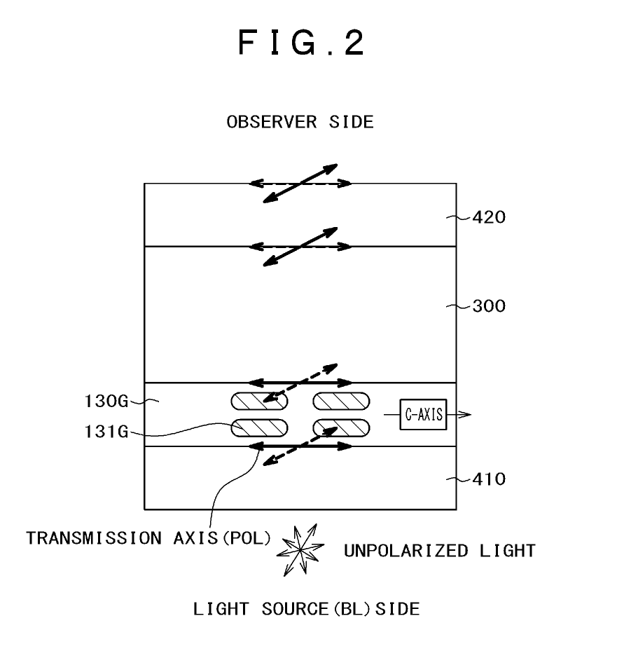

Next, the polarization states of light in the liquid crystal display device will be described with reference to FIGS. 2 to 4. FIG. 2 is a schematic diagram for explaining the polarization states of light in the liquid crystal display device in the case in which the transmission axes of the first and second polarizers 410 and 420 are in parallel with the C-axis of the quantum rod. In FIG. 2, only the first and second polarizers 410 and 420, the wavelength conversion layer 130G including the green quantum rod 131G, and the liquid crystal layer 300 are illustrated, and other components are omitted.

In FIG. 2, the second polarizer 420, the liquid crystal layer 300, the wavelength conversion layer 130G including the green quantum rod 131G formed on the TFT substrate 110, and the first polarizer 410 are disposed from an observer in this order. The first polarizer 410 is opposed to the light source (BL). Pumping light (unpolarized light) emitted from the backlight (the light source) 500 is converted into linearly polarized light at the first polarizer 410, and entered to the green quantum rod 131G in the wavelength conversion layer 130G. The linearly polarized pumping light is converted into green linearly polarized light along the C-axis (unchanged) at the green quantum rod 131G. The green light emitted from the green quantum rod 131G is entered to the liquid crystal layer 300 as unchanged. In the case of using the wavelength conversion layer 130R including the red quantum rod 131R, pumping light is converted into red linearly polarized light along the C-axis (unchanged) at the red quantum rod 131R and then emitted.

In the quantum rod, the planes of polarization of pumping light and emission light are not always accurately rotated at π/2. The planes of polarization are sometimes slightly displaced. The degree of displacement depends on a material for use, the degree of orientation, or processes. Desirably, the disposition of the quantum rods, the first and second polarizers 410 and 420, and other components is adjusted so that the maximum transmittance can be obtained.

The first and second polarizers 410 and 420 are disposed on crossed nicols. The major axis and C-axis of the quantum rod are matched with the transmission axis of polarized light. Thus, in the case in which a voltage applied to the liquid crystal layer 300 is off, light is not modulated in the liquid crystal layer 300. Consequently, the green light entered to the liquid crystal layer 300 is absorbed at the second polarizer 420 for black display. On the other hand, in the case in which a voltage applied to the liquid crystal layer 300 is on, the incident light is modulated in the liquid crystal layer 300. Consequently, the phase is changed, and the light is transmitted through the second polarizer 420 for normally black in white display.

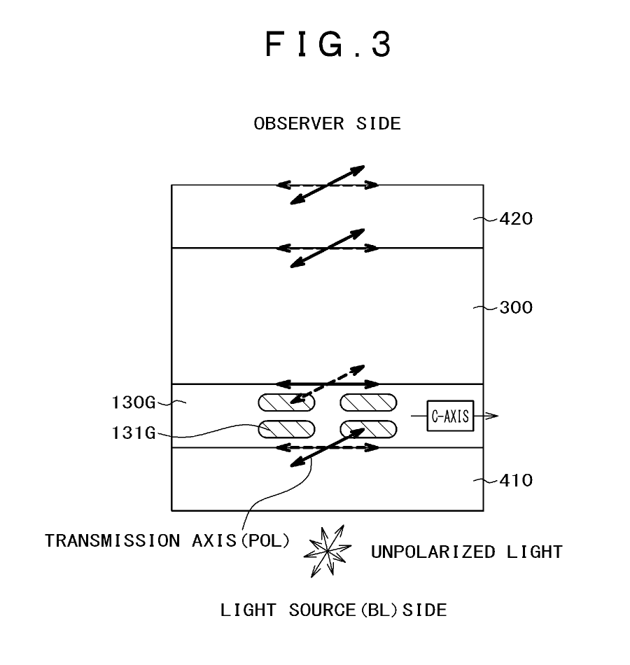

FIG. 3 is a schematic diagram for explaining the polarization states of light in the liquid crystal display device in the case in which the transmission axes of the first and second polarizers 410 and 420 are perpendicular to the C-axis of the quantum rod. Similarly to FIG. 2, also in FIG. 3, only the first and second polarizers 410 and 420, the wavelength conversion layer 130G including the green quantum rod 131G, and the liquid crystal layer 300 are illustrated, and other components are omitted.

In FIG. 3, the second polarizer 420, the liquid crystal layer 300, the wavelength conversion layer 130G including the green quantum rod 131G formed on the TFT substrate 110, and the first polarizer 410 are disposed from an observer in this order. The first polarizer 410 is opposed to the light source (BL). Pumping light (unpolarized light) emitted from the backlight (the light source) 500 is converted into linearly polarized light at the first polarizer 410, and entered in the direction orthogonal to the C-axis of the green quantum rod 131G in the wavelength conversion layer 130G. The linearly polarized pumping light is converted into green linearly polarized light along the C-axis at the green quantum rod 131G. The green light emitted from the green quantum rod 131G is entered to the liquid crystal layer 300 as unchanged. In the case of using the wavelength conversion layer 130R including the red quantum rod 131R, pumping light is converted into red linearly polarized light along the C-axis at the red quantum rod 131R, and then emitted.

In the quantum rod, the planes of polarization of pumping light and emission light are not always accurately rotated at π/2. The planes of polarization are sometimes slightly displaced. The degree of displacement depends on a material for use, the degree of orientation, or processes. Desirably, the disposition of the quantum rods, the first and second polarizers 410 and 420, and other components is adjusted so that the maximum transmittance can be obtained.

The first and second polarizers 410 and 420 are disposed on crossed nicols. The major axis and C-axis of the quantum rod are matched with the transmission axis of polarized light. Thus, in the case in which a voltage applied to the liquid crystal layer 300 is off, light is not modulated in the liquid crystal layer 300. Consequently, the green light entered to the liquid crystal layer 300 is absorbed at the second polarizer 420 for black display. On the other hand, in the case in which a voltage applied to the liquid crystal layer 300 is on, the incident light is modulated in the liquid crystal layer 300. Consequently, the phase is changed, and the light is transmitted through the second polarizer 420 for normally black in white display.

In the case in which the backlight (the light source) 500 emits ultraviolet light, the wavelength conversion layer 130B including the blue quantum rod 131B is disposed on the blue pixel region as illustrated in FIG. 1. On the other hand, in the case in which the backlight 500 emits blue light (visible light), there is no quantum rod to emit blue light caused by blue pumping light. Thus, the wavelength conversion layer 130B including the blue quantum rod 131B is not enabled to be disposed on the blue pixel region.

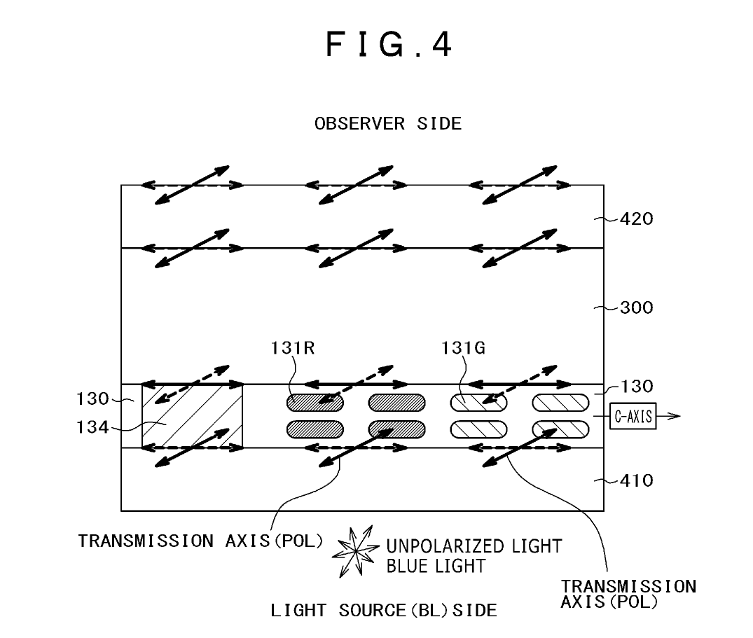

The configuration in the case of using blue pumping light will be described with reference to FIG. 4. The red pixel region and the green pixel region have configurations similar to the configuration illustrated in FIG. 3. In the blue pixel region, a transparent resin is disposed instead of the wavelength conversion layer 130B. However, in this configuration, the polarization state of blue light is not matched with the polarization states of red and green light. Thus, it is necessary to displace the phase of blue light by n. More specifically, in the blue pixel region, a half-wave plate 134 is disposed on any layer below the second polarizer 420 and near to the backlight 500. In the embodiment, the half-wave plate 134 was disposed on the same layer as the wavelength conversion layer 130. With this configuration, the polarization state of blue light is enabled to be matched with the polarization states of red and green light.

A display device having the configurations in FIGS. 1, 5, and 6 was manufactured. Consequently, the power consumption of the backlight and the absorption of light from the light source were greatly decreased, attaining an improvement about three times the case of using color filters in the ratio of light intensity to electric power. Thus, a decrease in power consumption was achieved.

As described above, according to the embodiment, the wavelength conversion layer including the quantum rod is used. Thus, it is possible to provide a display device that can improve the use efficiency of light from a light source and achieve low power consumption with a simple configuration even in the case in which no color filter is used.

### Second Embodiment

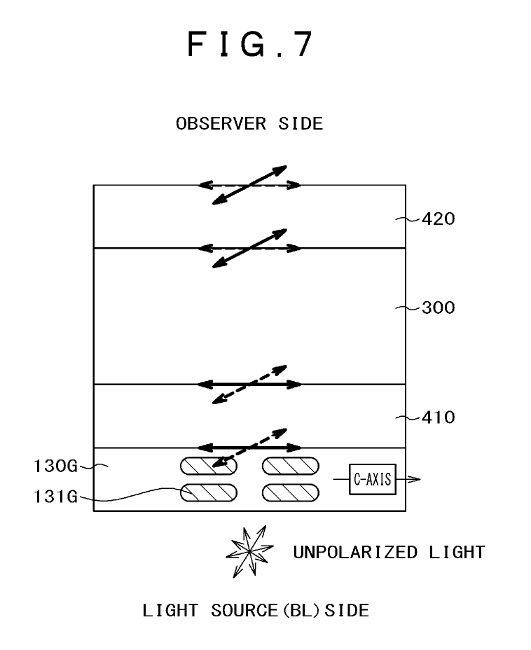

A second embodiment of the present invention will be described with reference to FIG. 7. Matters described in the first embodiment but not described in the second embodiment are also applicable to the second embodiment unless otherwise specified.

FIG. 7 is a schematic diagram for explaining the polarization states of light in a liquid crystal display device according to the embodiment (in the case in which the transmission axes of the first and second polarizers 410 and 420 are in parallel with the C-axis of the quantum rod). In FIG. 7, only the first and second polarizers 410 and 420, the wavelength conversion layer 130G including the green quantum rod 131G, and the liquid crystal layer 300 are illustrated, and other components are omitted.

In FIG. 7, the second polarizer 420, the liquid crystal layer 300, the first polarizer 410, and the wavelength conversion layer 130G including the green quantum rod 131G are disposed from an observer in this order. To the first polarizer 410, the wavelength conversion layer 130G is opposed to the light source (BL). In the first polarizer 410, the major axis and C-axis of the green quantum rod are matched with the transmission axis of polarized light so that only polarized light along the C-axis of the green quantum rod 131G is transmitted.

Pumping light (unpolarized light) emitted from the backlight (the light source) 500 is entered to the green quantum rod 131G in the wavelength conversion layer 130G. The unpolarized pumping light is converted into green linearly polarized light in the C-axis direction at the green quantum rod 131G. Only polarized light along the C-axis is transmitted through the first polarizer 410, and then entered to the liquid crystal layer 300. In the case of using the wavelength conversion layer 130R including the red quantum rod 131R, pumping light is converted into red linearly polarized light in the C-axis direction at the red quantum rod 131R, and then emitted. The disposition of the axes of the quantum rods is configured the same in the green and red quantum rods 131G and 131R.

In the quantum rod, the planes of polarization of pumping light and emission light are not always accurately rotated at π/2. The planes of polarization are sometimes slightly displaced. The degree of displacement depends on a material for use, the degree of orientation, or processes. Desirably, the disposition of the quantum rods, the first and second polarizers 410 and 420, and other components is adjusted so that the maximum transmittance can be obtained.

The first and second polarizers 410 and 420 are disposed on crossed nicols. The major axis and C-axis of the quantum rod are matched with the transmission axis of polarized light. Thus, in the case in which a voltage applied to the liquid crystal layer 300 is off, light is not modulated in the liquid crystal layer 300. Consequently, the green light entered to the liquid crystal layer 300 is absorbed at the second polarizer 420 for black display. On the other hand, in the case in which a voltage applied to the liquid crystal layer 300 is on, the incident light is modulated in the liquid crystal layer 300. Consequently, the phase is changed, and the light is transmitted through the second polarizer 420 for normally black in white display.

In the case in which the backlight 500 emits ultraviolet light (pumping light), the wavelength conversion layer 130B including the blue quantum rod 131B is disposed on the blue pixel region. The disposition of the first and second polarizers 410 and 420 and other components is configured the same in the red pixel region and the green pixel region.

In the case in which the backlight 500 emits blue light, which is visible light, a transparent resin is disposed, instead of the wavelength conversion layer 130B including the blue quantum rod 131B. A half-wave plate, for example, is disposed on any layer below the second polarizer 420 and near to the backlight 500 in order to align the phase of blue light with the phases of red and green light.

A display device having the configurations in FIGS. 5, 6, and 7 was manufactured. Consequently, the power consumption of the backlight and the absorption of light from the light source were greatly decreased, attaining an improvement about three times the case of using color filters in the ratio of light intensity to electric power. Thus, a decrease in power consumption was achieved.

The wavelength conversion layer 130 was disposed near to the light source 500 instead of the first polarizer 410. Consequently, in the case in which a defect was found in the display device in characteristic evaluation, easy analysis of the defect and easy repairing the display device were allowed.

As described above, according to the embodiment, the wavelength conversion layer including the quantum rod is used. Thus, it is possible to provide a display device that can improve the use efficiency of light from a light source and achieve low power consumption with a simple configuration even in the case in which no color filter is used.

The embodiments of the present invention are described. However, these embodiments are presented as examples, which will not limit the scope of the present invention. These novel embodiments can be implemented in other various forms, and can be variously omitted, replaced, and modified within the gist of the present invention. The embodiments and the modifications of the embodiments are included in the scope and the gist of the present invention, and also included in the invention in claims and ones equivalent to claims.

In the scope of the idea of the present invention, a person skilled in the art would think of various modifications and alterations. It will be understood that these modifications and alterations are also included in the scope of the present invention. For example, a person skilled in the art would appropriately add the component to or remove the component from the foregoing embodiments or change the design of the components of the foregoing embodiments, add or omit the process, or change the conditions. Any obtained ones that can be included in the gist of the present invention are included in the scope of to the present invention. It will be understood that other operations and effects derived from the forms described in the embodiments, which are apparent from the description of the present specification or can be appropriately thought by a person skilled in the art, are of course derived from the present invention.

What is claimed is:

1. A display device comprising:
a substrate having a display region and a thin film transistor disposed on the display region;
a wavelength conversion layer disposed on a region corresponding to the display region and including a columnar quantum rod having a major axis and a minor axis; and
a light source that excites the quantum rod.

2. The display device according to claim 1,
wherein: the quantum rod has a core and a shell surrounding the core; and
a value of a diameter of the core ranges from 1 to 20 nm.

3. The display device according to claim 1,
wherein: the light source emits ultraviolet light;
the display region includes a blue pixel region, a red pixel region, and a green pixel region;
the wavelength conversion layer corresponding to the blue pixel region includes a quantum rod that emits blue light by applying the ultraviolet light;
the wavelength conversion layer corresponding to the red pixel region includes a quantum rod that emits red light by applying the ultraviolet light; and
the wavelength conversion layer corresponding to the green pixel region includes a quantum rod that emits green light by applying the ultraviolet light.

4. The display device according to claim 1,
wherein: the light source emits blue light;
the display region includes a blue pixel region, a red pixel region, and a green pixel region;
the wavelength conversion layer corresponding to the red pixel region includes a quantum rod that emits red light by applying the blue light;
the wavelength conversion layer corresponding to the green pixel region includes a quantum rod that emits green light by applying the blue light; and
the blue pixel region includes a transparent resin and a half-wave plate.

5. A display device comprising:
a first substrate having
a display region including a blue pixel region, a red pixel region, and a green pixel region,
a thin film transistor disposed on the display region,
a scanning signal line electrically connected to a gate electrode of the thin film transistor, and
a picture signal line electrically connected to a source electrode of the thin film transistor;
a second substrate formed with a black matrix, the second substrate being disposed opposed to the first substrate, the black matrix being formed between pixel regions adjacent to each other, the pixel region corresponding to the blue pixel region, the red pixel region, or the green pixel region;
a liquid crystal layer sandwiched between the first substrate and the second substrate;
a wavelength conversion layer disposed on a region corresponding to the display region and including a plurality of columnar quantum rods having a major axis and a minor axis;
a quantum rod alignment unit disposed at a location overlapping with the black matrix when viewed from perpendicularly above for aligning an orientation of the plurality of quantum rods;
a light source that excites the plurality of quantum rods; and
a first polarizer, to the liquid crystal layer, disposed near to the light source and a second polarizer, to the liquid crystal layer, disposed on the opposite side of the light source.

6. The display device according to claim 5,
wherein the wavelength conversion layer is disposed near to the first substrate instead of the liquid crystal layer.

7. The display device according to claim 5,
wherein the wavelength conversion layer is disposed near to the second substrate instead of the liquid crystal layer.

8. The display device according to claim 5,
wherein the wavelength conversion layer was disposed near to the light source instead of the first polarizer.

9. The display device according to claim 5,
wherein the major axis of the quantum rod is matched with a C-axis of a wurtzite crystal.

10. The display device according to claim 9,
wherein a C-axis of the quantum rod is disposed on parallel with a transmission axis of the first polarizer.

11. The display device according to claim 9,
wherein a C-axis of the quantum rod is disposed perpendicular to a transmission axis of the first polarizer.

12. The display device according to claim 5,
wherein: the quantum rod has a core and a shell surrounding the core; and
a value of a diameter of the core ranges from 1 to 20 nm.

13. The display device according to claim 5,
wherein: the light source emits ultraviolet light;
the wavelength conversion layer corresponding to the blue pixel region includes a quantum rod that emits blue light by applying the ultraviolet light;
the wavelength conversion layer corresponding to the red pixel region includes a quantum rod that emits red light by applying the ultraviolet light; and
the wavelength conversion layer corresponding to the green pixel region includes a quantum rod that emits green light by applying the ultraviolet light.

14. The display device according to claim 5,
wherein: the light source emits blue light;
the wavelength conversion layer corresponding to the red pixel region includes a quantum rod that emits red light by applying the blue light;
the wavelength conversion layer corresponding to the green pixel region includes a quantum rod that emits green light by applying the blue light; and
the blue pixel region includes a transparent resin and a half-wave plate.

15. The display device according to claim 5,
wherein the light source emits light in a range of 200 to 490 nm.
